(19) United States
(12) Patent Application Publication
(10) Pub. No.: US 2025/0356450 A1
(43) Pub. Date: Nov. 20, 2025

(54) Systems and Methods for Achieving Greater Image Generation Refresh Rates via Source Buffer Swap

(71) Applicant: Apple Inc., Cupertino, CA (US)

(72) Inventors: Assaf Menachem, Hod Hasharon (IL); Itai Lanel, Haifa (IL); Daniel Y Dar, Givatayim (IL)

(21) Appl. No.: 18/894,681

(22) Filed: Sep. 24, 2024

Related U.S. Application Data
(60) Provisional application No. 63/647,587, filed on May 14, 2024.

(51) Int. Cl. G06T 1/60; G06T 1/20

(52) U.S. Cl. CPC G06T 1/60; G06T 1/20

(57) ABSTRACT

A GPU may process images at a faster rate than the electronic display can display them, causing the rendered image data to be several frames ahead of the electronic display. If it is determined that the GPU is ahead of the display, a more recent frame may be displayed on the electronic display during display of a present image frame by swapping from a first source buffer including the older image data to a second source buffer including the newest image data received from the GPU. While swapping source buffers mid-frame may result in a momentary screen tear, in some applications a momentary screen tear may be desirable if greater refresh rate is enabled, lag/latency is reduced or eliminated and screen judder is mitigated or prevented.

### CROSS-REFERENCE TO RELATED APPLICATIONS

This application claims priority to and benefit of U.S. Provisional Application No. 63/647,587, filed May 14, 2024, and entitled “Systems and Methods for Achieving Greater Image Generation Refresh Rates via Source Buffer Swap,” which is incorporated herein by reference in its entirety for all purposes.

### BACKGROUND

This disclosure relates to systems and methods for enabling higher image generation refresh rates on an electronic display with source buffer swapping.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Screen tearing is a visual artifact that occurs when an electronic display simultaneously presents portions of different frames, resulting in one or more disjointed portions of the displayed content known as “tears.” Screen tearing occurs when the refresh rate of an electronic display is not synchronized with a refresh rate of a graphics processing unit (GPU). Vertical synchronization (or VSync) is a display feature that is designed to maintain synchronization between the frame rate of the electronic display by throttling the refresh rate of the GPU to match the refresh rate of the electronic display. Judder is a visual artifact that occurs when the frame presentation time is not met. Judder may cause content to appear choppy and uneven, negatively impacting viewing experience.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In some circumstances, it may be desirable to enable the higher refresh rates achievable by the GPU, even if that results in a momentary screen tear. The GPU may process image data at a faster rate than the electronic display can display them, causing the GPU to be several frames ahead of the electronic display. If it is determined that the GPU is ahead of the display, a more recent (e.g., newer, newest) frame may be displayed on the display during display of an older image frame by swapping from a first source buffer that provides the older image data to a second source buffer that provides the newest image data received from the GPU. This source buffer swap may be referred to as an “immediate” swap as it may occur during display of a present frame of older image data (causing a screen tear between the old image data and the new image data), rather than waiting until a new frame is displayed and displaying only the newest image data on the display during the new frame. While the immediate swap may result in a screen tear, in some applications a momentary screen tear may be desirable if greater refresh rate is enabled, latency and/or lag is reduced or eliminated, and judder is reduced or eliminated. It should be noted that multiple buffer swaps may occur per-frame. That is, during a single frame a first source buffer may be swapped for a second source buffer, the second source buffer may be swapped for a third source buffer, and the third source buffer may be swapped for a fourth source buffer. Indeed, any appropriate number of source buffer swaps may occur during a single frame time during display of content.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is another example of the electronic device of FIG. 1 in the form of a virtual reality (VR)/augmented reality (AR) headset, in accordance with an embodiment;

FIG. 8 includes an image processing system including a first source buffer and a second source buffer leverageable to provide immediate source buffer swaps, in accordance with an embodiment;

FIG. 9 is an illustration of the source buffer swap, in accordance with an embodiment;

FIG. 10 is a flowchart of a method for performing a preliminary analysis to determine if a source buffer swap may be approved, in accordance with an embodiment;

FIG. 11 is a flowchart of a method for determining a tear line location and swapping from the first source buffer described in FIG. 8 to the second source buffer described in FIG. 8, in accordance with an embodiment;

FIG. 12 is a diagram of a single display pipeline architecture, in accordance with an embodiment;

FIG. 13 is a diagram of a multi-pipeline display architecture, in accordance with an embodiment;

FIG. 14 is an illustration of the operation of the source buffer swap and the determination of the tear offset from the perspective of the source buffer and a destination buffer, in accordance with an embodiment;

FIG. 15 is a flowchart of a method for determining the location of the tear line and swapping source buffers, in accordance with an embodiment;

FIG. 16 is a timing diagram illustrating points in time during the display of one or more frames in which source buffer swaps are or are not allowed, in accordance with an embodiment;

FIG. 17 is a timing diagram illustrating a scenario wherein a swap request is accepted in a single pipeline architecture as described with respect to FIG. 12, in accordance with an embodiment;

FIG. 18 is a timing diagram illustrating a scenario wherein a swap request is denied in a single pipeline architecture as described with respect to FIG. 12, in accordance with an embodiment;

FIG. 19 is a timing diagram illustrating a scenario wherein a swap request is accepted in the multi-pipeline architecture as described with respect to FIG. 13, in accordance with an embodiment;

FIG. 20 is a timing diagram illustrating a scenario wherein a swap request is denied in the multi-pipeline architecture as described with respect to FIG. 13, in accordance with an embodiment;

FIG. 21 is a timing diagram illustrating another scenario wherein a swap request is denied in the multi-pipeline architecture as described with respect to FIG. 13, in accordance with an embodiment; and

FIG. 22 is a timing diagram illustrating another scenario wherein a swap request is denied in the multi-pipeline architecture as discussed with respect to FIG. 13, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Screen tearing is a visual artifact that occurs when an electronic display simultaneously presents portions of different frames, resulting in one or more disjointed portions of the displayed content known as “tears.” Screen tearing occurs when the refresh rate of an electronic display is not synchronized with a refresh rate of a graphics processing unit (GPU). Vertical synchronization (or VSync) is a display feature this is designed to maintain synchronization between the frame rate of the electronic display by throttling the refresh rate of the GPU to match the refresh rate of the electronic display.

As the GPU may process images at a faster rate than the electronic display can display them, the GPU may be several frames ahead of the electronic display. If it is determined (e.g., by display pipeline control circuitry) that the GPU is ahead of the display, a more recent (e.g., newer) frame may be displayed on the electronic display throughout the frame irrespective of VSync. That is, if a first source buffer has the older image data being displayed on a portion of the electronic display, and a second source buffer has new image data one or more frames ahead of the present image data, a display controller may request a source buffer swap to switch from the first source buffer to the second source buffer and display the newest image data. The source buffer swap may be an “immediate” swap, meaning that the image content will change mid-frame, rather than a delayed (e.g., non-immediate) swap (e.g., referred to in some instances as VSync Swap), in which case the new image data will not be displayed until the new frame is processed and displayed on the electronic display. That is, “immediate” is intended to indicate that image data changes mid-frame, resulting in a screen tear at a line where the first source buffer is switched out and the second source buffer is used to supply the newest image data, and thus immediate may mean “substantially immediate.” The image data swap may be instantaneous, but not necessarily so as the old image data may remain on the electronic display for a period of time after the source buffer swap before being flushed out. While an immediate source buffer swap may result in a momentary screen tear, in some applications, a momentary screen tear may be desirable if greater refresh rate is enabled, latency/lag is mitigated or prevented, and screen judder is mitigated or prevented. The tear line may be determined based on a tear offset. The tear offset may be determined from a buffer line during which a swap request was approved and may account for the sum of multiple worst-case conditions, such that the display pipeline hardware is able to ensure completion of the source buffer swap in a deterministic (e.g., pre-determined) line on the source buffer. Providing a source buffer swap at a deterministic buffer address may reduce or minimize the impact of the image artifact (e.g., the tear line) and may limit the amount of data prefetched by display pipeline circuitry, reducing swap latency and increasing display efficiency, among other benefits.

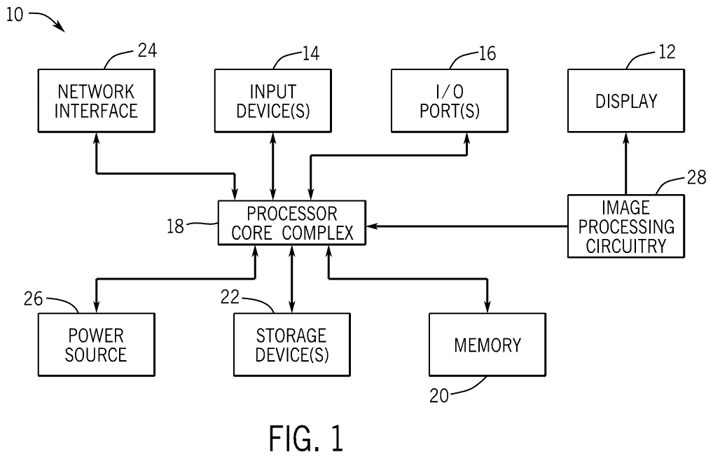

With the foregoing in mind, FIG. 1 is an example electronic device 10. As described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include one or more electronic displays 12, input devices 14, input/output (I/O) ports 16, a processor core complex 18 having one or more processors or processor cores, local memory 20, a main memory storage device 22, a network interface 24, a power source 26, and image processing circuitry 28. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component. Moreover, the image processing circuitry 28 (e.g., a graphics processing unit, a display image processing pipeline, etc.) may be included in the processor core complex 18 or be implemented separately.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to the image processing circuitry 28 for display on the electronic display 12. The image processing circuitry may include a graphics processing unit (GPU) or other image processing circuitry, and may perform one or more functions relating to the image data, such as image enhancement, filtering (e.g., to enhance color and/or remove noise), compression, feature extraction, object recognition, and so on. The processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a BLUETOOTH® network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices. The input devices 14 may enable a user to interact with the electronic device 10. For example, the input devices 14 may include buttons, keyboards, mice, trackpads, and the like. Additionally or alternatively, the electronic display 12 may include touch-sensing components that enable user inputs to the electronic device 10 by detecting the occurrence and/or position of an object touching its screen (e.g., surface of the electronic display 12).

The electronic display 12 may display a graphical user interface (GUI) (e.g., of an operating system or computer program), an application interface, text, a still image, and/or video content. The electronic display 12 may include a display panel with one or more display pixels to facilitate displaying images. Additionally, each display pixel may represent one of the sub-pixels that control the luminance of a color component (e.g., red, green, or blue). Although sometimes used to refer to a collection of sub-pixels (e.g., red, green, and blue subpixels) as used herein, the terms display pixel or pixel may refer to an individual sub-pixel (e.g., red, green, or blue subpixel).

As described above, the electronic display 12 may display an image by controlling the luminance output (e.g., light emission) of the sub-pixels based on corresponding image data. In some embodiments, pixel or image data may be generated by an image source, such as the processor core complex 18, a graphics processing unit (GPU), or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the image processing circuitry 28) for one or more external electronic displays 12, such as connected via the network interface 24 and/or the I/O ports 16.

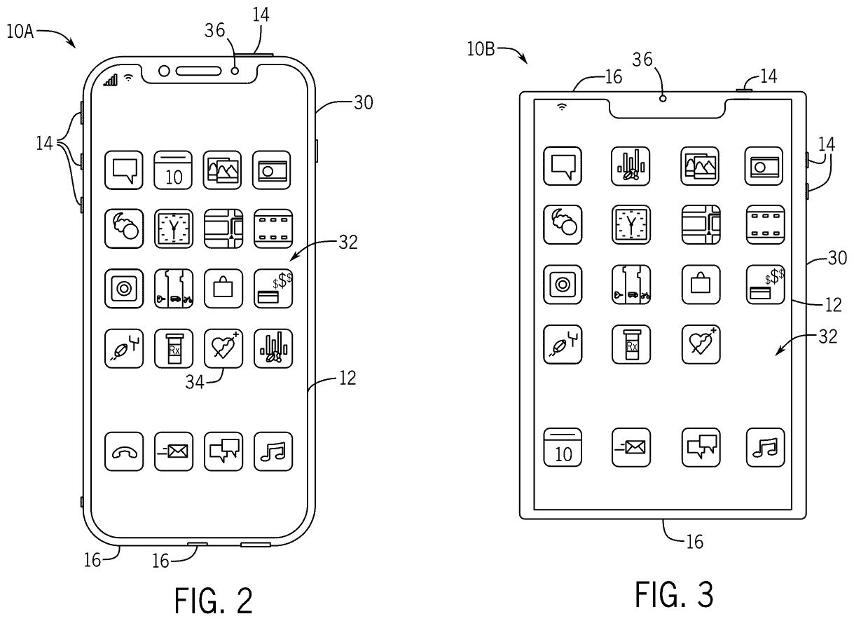

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an IPHONE® model available from Apple Inc.

The handheld device 10A may include an enclosure 30 (e.g., housing) to, for example, protect interior components from physical damage and/or shield them from electromagnetic interference. The enclosure 30 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 30. Moreover, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 16 may also open through the enclosure 30. Additionally, the electronic device may include one or more cameras 36 to capture pictures or video. In some embodiments, a camera 36 may be used in conjunction with a virtual reality or augmented reality visualization on the electronic display 12.

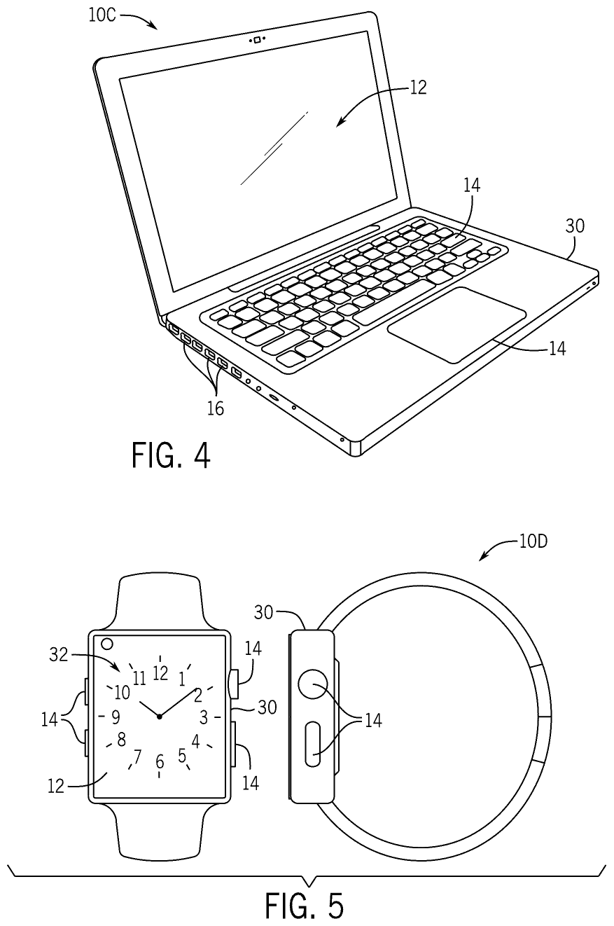

Another example of a suitable electronic device 10, specifically a tablet device 10B, is shown in FIG. 3. The tablet device 10B may be any IPAD® model available from Apple Inc. A further example of a suitable electronic device 10, specifically a computer 10C (e.g., notebook computer), is shown in FIG. 4. By way of example, the computer 10C may be any MACBOOK® model available from Apple Inc. Another example of a suitable electronic device 10 (e.g., a worn device), specifically a watch 10D, is shown in FIG. 5. By way of example, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

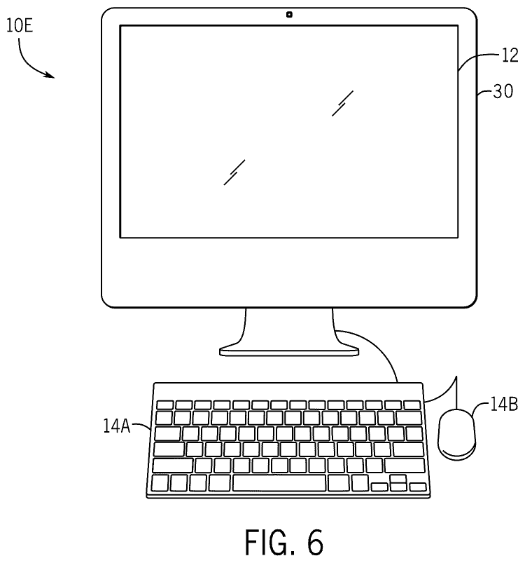

Turning to FIG. 6, a computer 10E may represent another embodiment of the electronic device 10 of FIG. 1. The computer 10E may be any suitable computer, such as a desktop computer or a server, but may also be a standalone media player or video gaming machine. By way of example, the computer 10E may be an IMAC® or other device by Apple Inc. of Cupertino, California. It should be noted that the computer 10E may also represent a personal computer (PC) by another manufacturer. A similar enclosure 30 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

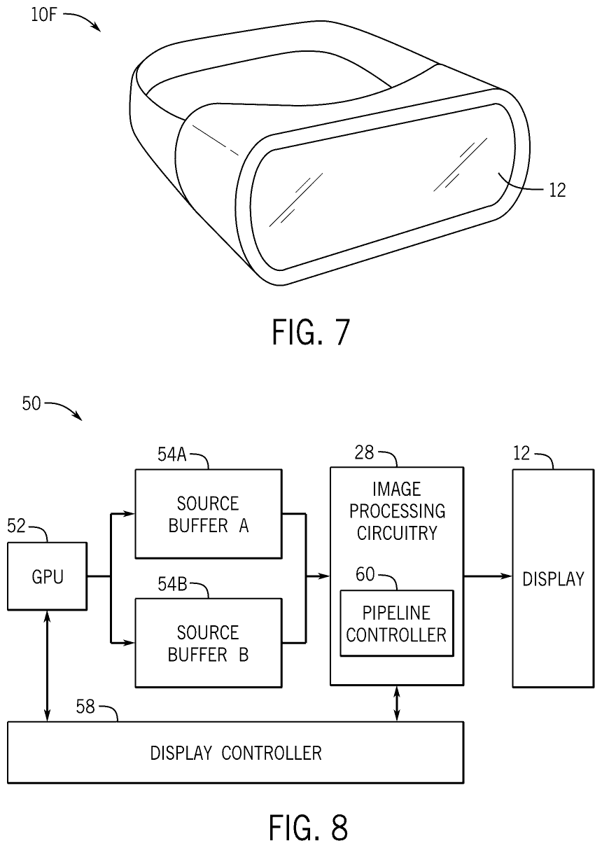

FIG. 7 shows yet another example of the electronic device 10 in the form of a headset 10F, such as virtual reality (VR) and/or augmented reality (AR) headset. The headset 10F may include any suitable headset. By way of example, the headset 10F may be an Apple Vision Pro™ or other device by Apple Inc. of Cupertino, California. It should be noted that the headset 10F may also represent a headset by another manufacturer. The headset 10F may include a display 12, such as a foveated display, with which the user may interact via eye-tracking, voice command, and/or gesture.

FIG. 8 illustrates an image processing system 50 that may provide immediate (e.g., substantially immediate) source buffer swaps. The image processing system 50 includes a graphics processing unit (GPU) 52 coupled to multiple source buffers (source buffer A 54A and source buffer B 54B, collectively the source buffers 54) and a display controller 58. The GPU 52 may render image data and output the image data to the source buffers 54. The source buffers 54 may store the rendered image data received from the GPU 52 and output the image data to the image processing circuitry 28 where the image data may undergo further processing. The image processing circuitry includes a pipeline controller 60, which may work in conjunction with the display controller 58 to effectuate immediate source buffer swaps.

As previously mentioned, because the GPU 52 may process frames of image data at a faster rate than the electronic display 12 can display them, the GPU 52 may be several frames ahead of the electronic display 12. If it is determined (e.g., by the pipeline controller 60) that the GPU 52 is ahead of the electronic display 12, image data corresponding to a more recent (e.g., newer, most recent, newest) frame may be displayed on the electronic display 12 irrespective of VSync. That is, if the source buffer A 54 has the present image data to be displayed on the electronic display, and the source buffer B 56 has new image data one or more frames ahead of the present image data, the display controller 58 may request a source buffer swap to swap from the source buffer A 54A to the source buffer B 54B and display the newest image data. This may result in a momentary screen tear; however, in some applications, a momentary screen tear may be desirable if greater refresh rate is enabled and screen judder is mitigated or prevented entirely. The tear line may be determined at a tear offset. The tear offset may be determined from a buffer line during which a swap request was approved and may account for the sum of multiple worst-case conditions, such that the display pipeline hardware is able to ensure completion of the source buffer swap in a deterministic (e.g., pre-determined) line on the source buffer. It should be noted that the image processing system 50 may include more than two source buffers. For example, the image processing circuitry may include three source buffers or more, five source buffers or more, ten source buffers or more, and so on. Moreover, there may be more than one source buffer swap during a frame. For example, there may be a third source buffer C, and during the duration of a single image frame there may be a swap from the source buffer A 54A to the source buffer B 54B and another swap from the source buffer B 54B to a third source buffer C (not shown).

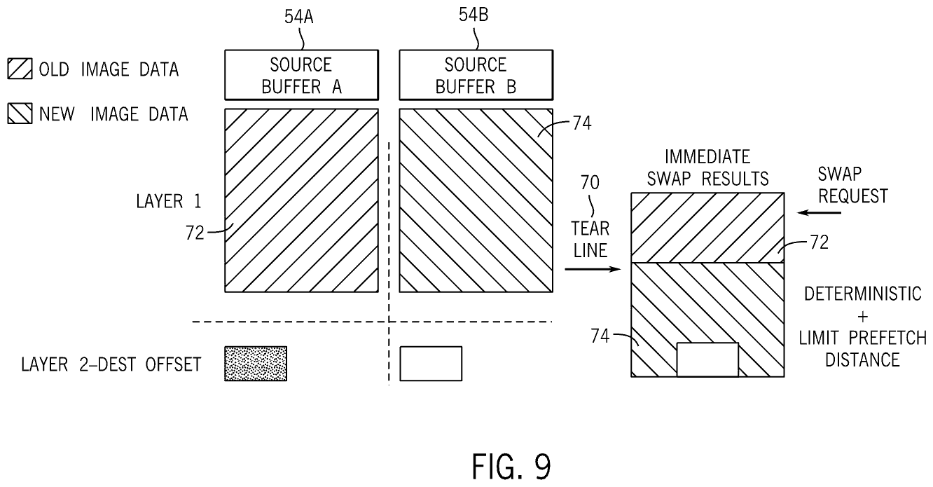

FIG. 9 is an illustration of the source buffer swap, according to embodiments of the present disclosure. As may be observed, the source buffer A 54A includes older image data 72 and the source buffer B 54B includes the new image data 74 received from the GPU 52. While the display pipeline is reading from the source buffer A 54A, the GPU 52 is writing to the source buffer B 54B. The GPU 52 and the electronic display 12 may both have information regarding which line the display pipeline is going to switch from the source buffer A 54A to the source buffer B 54B. The line at which the display pipeline swaps from the source buffer A 54A to the source buffer B 54B is referred to herein as a tear line 70. That is, the tear line 70 may be deterministic—meaning occurring at a predetermined location based on a tear offset—which will be discussed in greater detail below. Providing a deterministic tear line may reduce the impact of a visual artifact (e.g., the tear line) on a viewer by providing a clear tear across a single line. Providing a clear tear across a single line, as opposed to potentially dragging a screen tear across two lines, may reduce the impact of the visual artifact. Additionally, data prefetch from initial image processing circuitry may be limited (e.g., via an orthogonal knob).

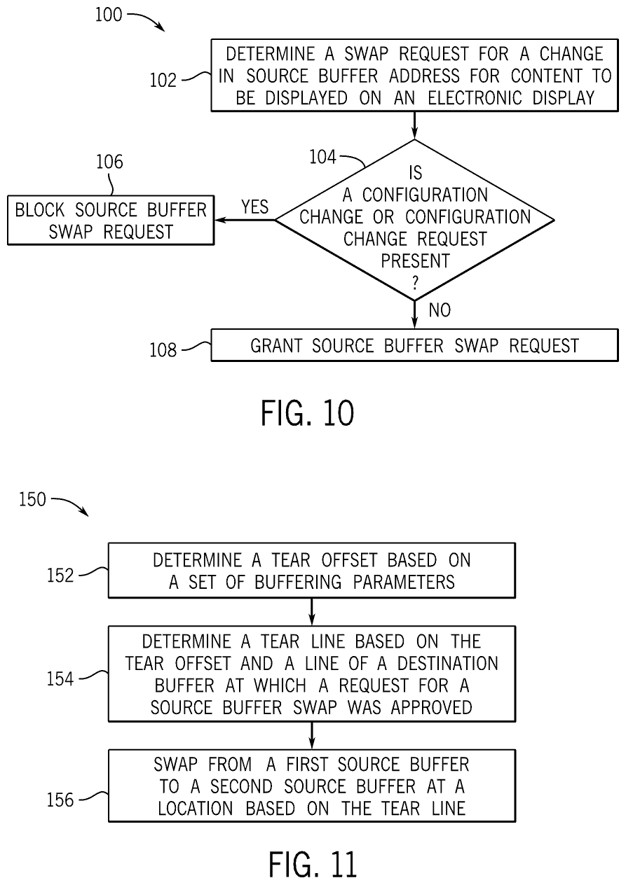

FIG. 10 is a flowchart of a method 100 for performing a preliminary analysis to determine if a source buffer swap may be enabled, according to embodiments of the present disclosure. Any suitable device that may control components of the electronic device 10, such as the processor core complex 18, the image processing circuitry 28 (including the pipeline controller 60), and/or the display controller 58 may perform the method 100. In some embodiments, the method 100 may be implemented by executing instructions stored in a tangible, non-transitory, computer-readable medium, such as the memory 20 or storage 22, using the processor core complex 18. For example, the method 100 may be performed at least in part by one or more software components, such as an operating system of the electronic device 10, one or more software applications of the electronic device 10, and the like. While the method 100 is described using steps in a specific sequence, it should be understood that the present disclosure contemplates that the described steps may be performed in different sequences than the sequence illustrated, and certain described steps may be skipped or not performed altogether.

In process block 102, the display controller 58 may determine a change in source buffer address for content to be displayed on the electronic display 12. For example, the display controller 58 may determine that the GPU 52 is rendering image data and loading the rendered image data into source buffer B 54B faster than the electronic display 12 may display the rendered content, and the display controller 58 may register a request to switch from the source buffer A 54A to the source buffer B 54B. In query block 104, the display controller 58 may determine whether any other configuration change is present. For example, other configuration changes that may block a source buffer swap include scaling, source format changes, ambient condition changes, and so on. If any other configuration change is determined, in process block 106 the display controller 58 may refrain from requesting a frame swap or, if the display controller 58 has requested a source buffer swap, the pipeline controller 60 may deny the request. However, if no other configuration changes are determined, then, in process block 108, the display controller 58 may request a source buffer swap, or the pipeline controller 60 may approve the request if the display controller 58 has already requested a source buffer swap. While the method 100 is discussed as being performed by the display controller 58, it should be noted that the method 100 may also be carried out by the image processing circuitry 28, specifically the pipeline controller 60. That is, if the display controller 58 sends a source buffer swap request to the image processing circuitry 28, the image processing circuitry 28 (e.g., the pipeline controller 60) may deny the request if a concurrent configuration change is detected.

FIG. 11 is a flowchart of a method 150 for determining a tear line location and swapping from a first source buffer (e.g., the source buffer A 54A) to a second source buffer (e.g., the source buffer B 54B), according to embodiments of the present disclosure. Any suitable device that may control components of the electronic device 10, such as the processor core complex 18, the image processing circuitry 28 (including the pipeline controller 60), and/or the display controller 58 may perform the method 150. In some embodiments, the method 150 may be implemented by executing instructions stored in a tangible, non-transitory, computer-readable medium, such as the memory 20 or storage 22, using the processor core complex 18. For example, the method 150 may be performed at least in part by one or more software components, such as an operating system of the electronic device 10, one or more software applications of the electronic device 10, and the like. While the method 150 is described using steps in a specific sequence, it should be understood that the present disclosure contemplates that the described steps may be performed in different sequences than the sequence illustrated, and certain described steps may be skipped or not performed altogether.

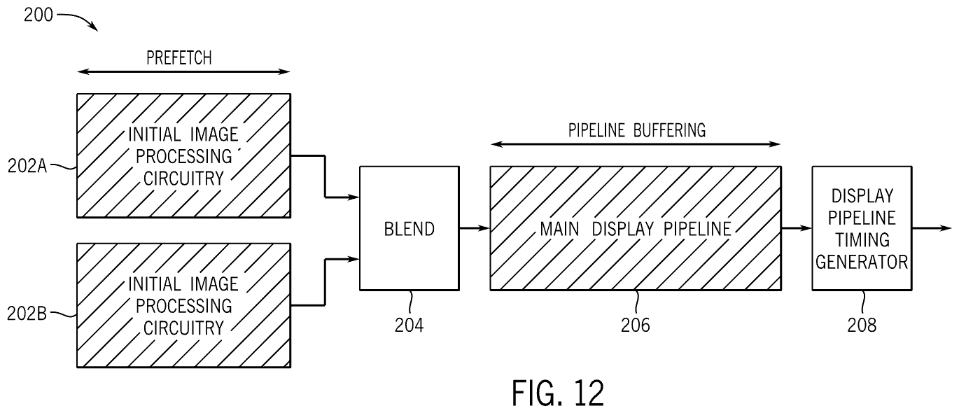

In process block 152, the pipeline controller 60 may determine a tear offset based on a set of buffering parameters, as will be discussed in greater detail with respect to FIGS. 12-14 below. In processing block 154, the pipeline controller 60 may determine a tear line based on the tear offset and a present line being written to the electronic display 12. In process block 156 the pipeline controller 60 may swap from a first buffer (e.g., the source buffer A 54A) to a second buffer B (e.g., the source buffer B 54B) to enable display of the most recent image data rendered by the GPU 52.

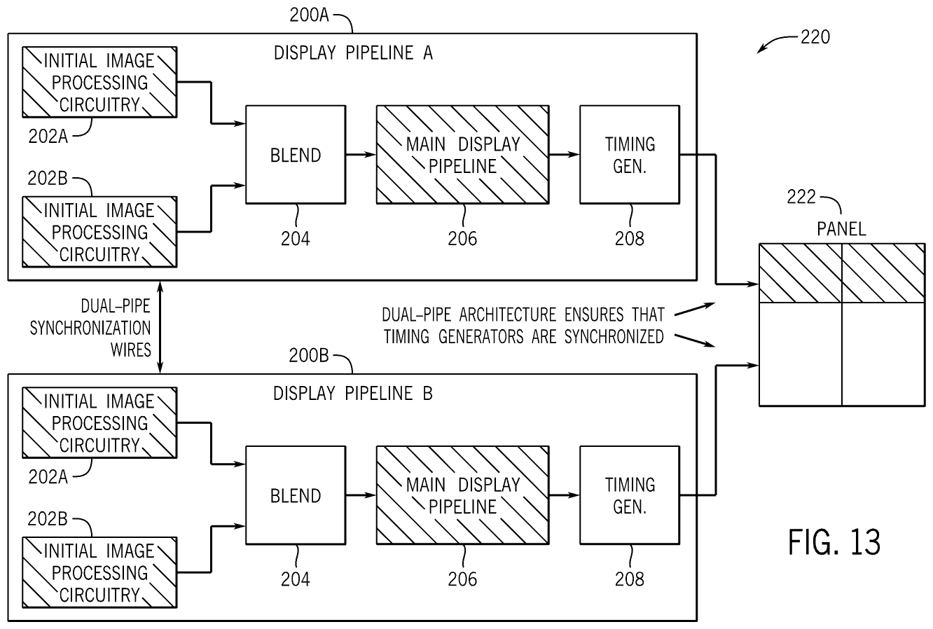

FIG. 12 is a block diagram of a display pipeline 200 in a single display pipeline architecture, according to embodiments of the present disclosure. The display pipeline 200 includes initial image processing circuitry 202A and 202B, blend circuitry 204, a main display pipeline 206, and a display pipeline timing generator 208. While blend circuitry 204 is illustrated as part of the display pipeline 200, it should be noted that blend may be excluded in some embodiments. The initial image processing circuitry 202A and 202B may prefetch data from the source buffers 54. It may be advantageous to limit the prefetch, as excessive prefetch may adversely impact swap latency. As used herein, swap latency is defined as the duration from when a source buffer swap request is accepted until the image data stored in the new source buffer is displayed on the electronic display 12. The prefetch of the initial image processing circuitry 202A and 202B may be achieved by conveying the maximal source line up to which the initial image processing circuitry 202A and 202B may be allowed to fetch. This value may be continuously computed in relation to the line being presently read onto the electronic display 12. The blend circuitry 204 may receive linear-space or gamma-space pixel streams from the initial image processing circuitry 202A and 202B and blend them together. The main display pipeline 206 may receive the blended image data from the blend circuitry 204 and perform additional processing on the blended image data. The main display pipeline 206 may include buffers for storing the blended image data. From the main display pipeline 206 the blended image data may be provided to the electronic display 12 for display. While only display pipeline 200 is shown, it should be noted that a dual-pipeline display architecture or multi-pipeline display architecture may be implemented, as will be discussed with respect to FIG. 13 below.

FIG. 13 is a block diagram of a dual-pipeline architecture 220, according to embodiments of the present disclosure. The dual-pipeline architecture 220 includes a display pipeline 200A and a display pipeline 200B. It should be noted that the display pipelines 200A and 200B may operate as described with respect to the display pipeline 200 of FIG. 12. The display pipelines 200A and 200B may each load image data into a display panel 222 from opposite sides of the display panel 222. For example, the display pipeline 200A may load image data into the display panel 222 from the left side and the display pipeline 200B may load image data into the display panel 222 from the right side, or vice versa.

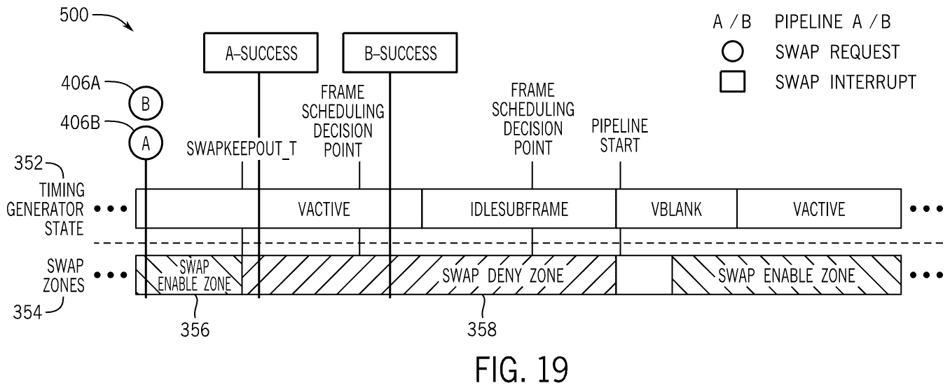

In the dual-pipeline architecture 220, it is beneficial to ensure that the respective display timing generators 208 of the display pipeline 200A and the display pipeline 200B remain synchronized. To ensure synchronization between the display pipeline 200A and the display pipeline 200B, a set of synchronization points may be relied upon: a swap request and an immediate swap trigger. The swap request may be generated from the display controller 58 and indicates a new VSyncOff frame (e.g., a frame for which an immediate source buffer swap may be implemented). The swap request may be asserted by the display controller 58 at the beginning of a new frame for both display pipelines 200A and 200B. To ensure synchronization for the swap request, both display pipelines 200A and 200B may receive the swap requests during a swap enable zone, as will be discussed in greater detail with respect to FIGS. 19-22. The display pipelines 200A and 200B communicate with each other to acknowledge that each have received the swap request. If only one of the display pipelines or neither of the display pipelines receives the swap request, the image processing circuitry 28 may not proceed with an immediate source buffer swap request. If both display pipelines 200A and 200B acknowledge that they have received the swap request, the image processing circuitry 28 may trigger an immediate source buffer swap for both display pipelines, ensuring that the tear line is synchronized across the display panel 222. That is, the tear line will be synchronized on the left side of the display panel 222 fed by the display pipeline 200A and the right side of the display panel 222 fed by the display pipeline 200B.

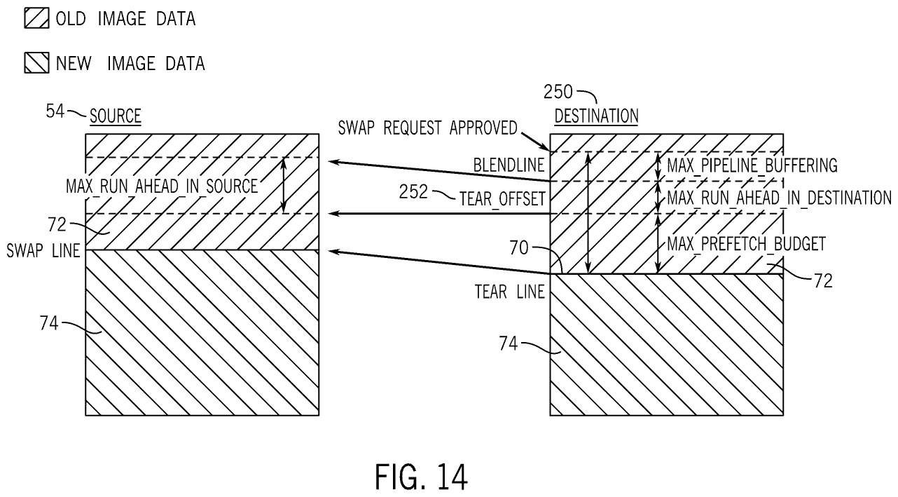

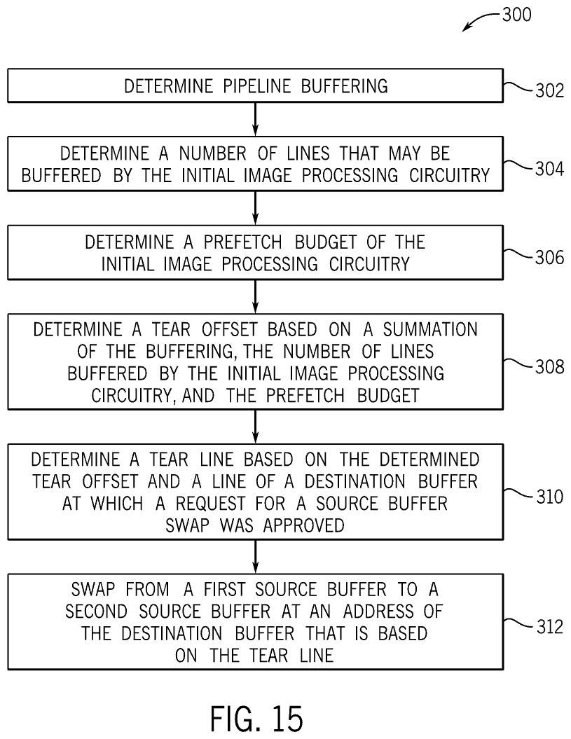

FIG. 14 is an illustration of the operation of the source buffer swap and the determination of the tear offset from the perspective of the source buffers 54 and a destination buffer 250, according to embodiments of the present disclosure. The source buffers 54 and the destination buffer 250 each include the old image data 72 and new image data 74. The tear line 70 is determined by display pipeline hardware based on a fixed offset, referred to as the tear offset 252. The tear offset 252 is an offset between a line number in which the source buffer swap request was approved in the destination buffer 250 and the tear line 70. The determination of the tear offset 252 will be discussed in greater detail with respect to FIG. 15 below.

FIG. 15 is a flowchart of a method 300 for determining the location of the tear line 70 and swapping source buffers, according to embodiments of the present disclosure. Any suitable device that may control components of the electronic device 10, such as the processor core complex 18, the image processing circuitry 28 (including the pipeline controller 60), and/or the display controller 58 may perform the method 300. In some embodiments, the method 300 may be implemented by executing instructions stored in a tangible, non-transitory, computer-readable medium, such as the memory 20 or storage 22, using the processor core complex 18. For example, the method 300 may be performed at least in part by one or more software components, such as an operating system of the electronic device 10, one or more software applications of the electronic device 10, and the like. While the method 300 is described using steps in a specific sequence, it should be understood that the present disclosure contemplates that the described steps may be performed in different sequences than the sequence illustrated, and certain described steps may be skipped or not performed altogether.

In process block 302, the pipeline controller 60 determines pipeline buffering, such as the maximum buffering of the main display pipeline 206 or the maximum buffering available in the main display pipeline 206. In process block 304, the pipeline controller 60 determines a number of lines that may be buffered by the initial image processing circuitry 202. In process block 306, the pipeline controller 60 may determine a prefetch budget (e.g., a maximum prefetch budget) of the initial image processing circuitry 202. In process block 308, the pipeline controller 60 may determine the tear offset 252 based on a summation of the pipeline buffering of the main display pipeline 206, the number of lines buffered by the initial image processing circuitry 202, and the prefetch budget of the initial image processing circuitry 202. The tear offset may account for the sum of the worst-case delay conditions, such that the display pipeline hardware is able to guarantee completing the swap in a deterministic location (e.g., at a deterministic address on the destination buffer 250). By accounting for the prefetch budget (e.g., the maximum prefetch budget), the pipeline controller 60 may limit or reduce the amount of data the image processing circuitry 28 is prefetching from the source buffers 54. That is, the image processing circuitry 28 may not prefetch data from the first source buffer 54A beyond the tear line (e.g., more prefetch data than the image processing circuitry 28 will use), reducing swap latency.

In process block 310, the pipeline controller 60 may determine the location of the tear line 70 based on the determined tear offset 252 and a particular line in the destination buffer 250 at which the swap request was approved, such that the tear line 70 is located at an address that is equal the tear offset 252 added to the particular line in the destination buffer 250. In process block 312, the pipeline controller 60 may effectuate a swap from a first source buffer (e.g., the source buffer A 54A) to a second source buffer (e.g., the source buffer B 54B) at an address of the destination buffer that is based on the tear line. In this manner, the method 300 may enable determining the location of the tear line 70 and effectuating a source buffer swap at the tear line 70.

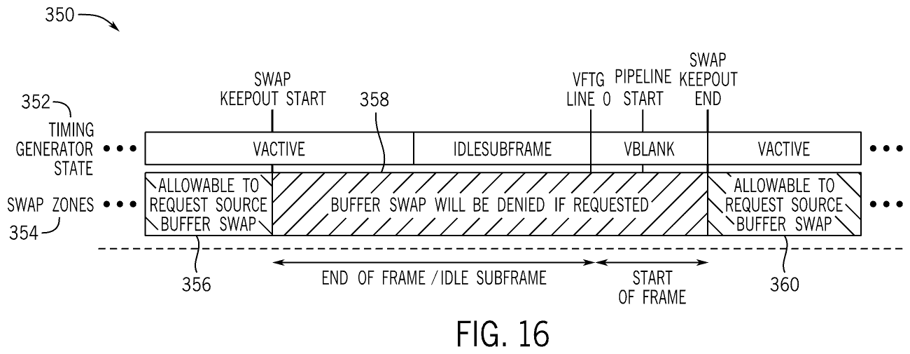

FIG. 16 is a timing diagram 350 illustrating points in time during the display of one or more frames in which source buffer swaps are or are not allowed, according to embodiments of the present disclosure. The timing diagram includes a timing generator state 352 and a swap zone 354. If a source buffer swap is requested (e.g., by the display controller 58) in a swap enable zone 356, the source buffer swap will be allowed. However, if a source buffer swap is requested (e.g., by the display controller 58) in a swap deny zone 358, the request will be blocked (e.g., by the pipeline controller 60). For example, source buffer swaps requested near the end of the active period or during the idle subframe period will be denied or blocked, as, at that point, the source buffer swap may be accomplished on a subsequent frame rather than immediately. That is, the timing of a presently presented frame of content (e.g., old image data) on the electronic display 12 is such that it would not be beneficial to immediately swap the frame content from the source buffer A 54A to the source buffer B 54B to display new content and create a tear line, as the image frame is near a refresh period, and the image data contained in the source buffer B 54B may be used on a subsequent frame, providing the newest image data without a frame tear.

The image processing circuitry 28 (e.g., the display pipeline 200 and/or the pipeline controller 60) may return a status based on the swap request. If the requested source buffer swap is qualified and the image processing circuitry 28 approves the swap process, the image processing circuitry 28 may return a Swap Approved status. For example, the image processing circuitry 28 may approve the swap request if there is no configuration change present, as discussed with respect to the query block 104 of FIG. 10, or the swap request does not occur at the end of an active frame or within the Idle Subframe period. Conversely, the image processing circuitry 28 may deny the swap request and return a Swap Denied status if there is a configuration change present, or if the swap request occurs at the end of the active period, or during the Idle Subframe periods. If the swap request has been approved, the image processing circuitry 28 may return a Swap Success status if the swap was successfully completed (e.g., that the initial image processing circuitry 202 begins fetching data from the new source buffer during VSyncOff). Alternatively, the image processing circuitry 28 may return a Swap Error status if the swap was initiated but failed to successfully complete prior to completion of a presently displayed frame (e.g., due to unexpected failure, similar to an under-run).

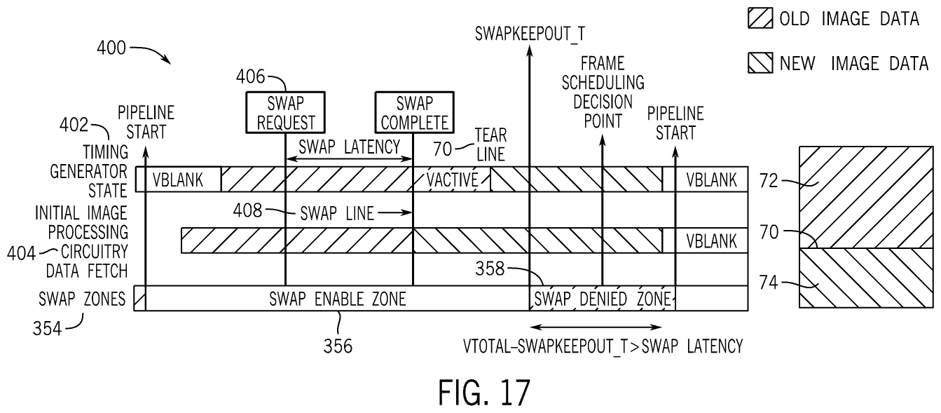

FIG. 17 is a timing diagram 400 illustrating a scenario wherein a swap request is accepted in a single pipeline architecture, according to embodiments of the present disclosure. The timing diagram 400 includes timing generator data 402, initial image processing circuitry data fetch 404, and the swap zones 354. As previously discussed, the display controller 58 may issue a swap request 406 to display pipeline circuitry (e.g., the image processing circuitry 28). The image processing circuitry 28 may determine if the swap request 406 is qualified. As may be observed, the swap request 406 is transmitted in the swap enable zone 356. The initial image processing circuitry 202 may swap from a first source buffer to a second source buffer at the swap line 408. The swap line is defined as the source buffer line where the initial image processing circuitry 202 switches from a present source buffer to the new source buffer. The swap line exists in the source domain. The display may not begin to display the new image data 74 until the timing generator data 402 is flushed out from the electronic display 12. The new image data 74 will replace the old image data 72 at the tear line 70, as previously discussed.

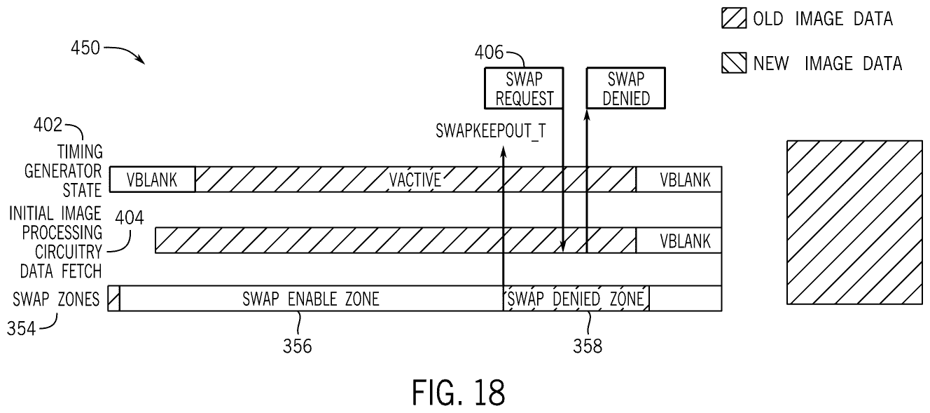

FIG. 18 is a timing diagram 450 illustrating a scenario wherein a swap request is denied in a single pipeline architecture, according to embodiments of the present disclosure. As may be observed, the swap request 406 is issued (e.g., by the display controller 58) within the swap deny zone 358, as discussed with respect to FIG. 16. As the request was made too late (e.g., in the swap deny zone 358), the swap request will be denied, the initial image processing circuitry 202 will continue to fetch the old image data 72 from the first source buffer, and the new image data 74 may not be provided to the electronic display 12 until a following frame.

FIG. 19 is a timing diagram 500 illustrating a scenario wherein a swap request is accepted in the dual-pipeline architecture 220 as discussed with respect to FIG. 13, according to embodiments of the present disclosure. As discussed with respect to FIG. 13, the swap requests (e.g., 406A and 406B, collectively the swap requests 406) for the display pipeline 200A and the display pipeline 200B will be allowed if they are synchronized (e.g., if the swap request 406A is received by the display pipeline 200A and the swap request 406B is received by the display pipeline 200B during the swap enable zone 356). From the timing diagram 500, it may be seen that the swap requests 406A and 406B are made simultaneously during the swap enable zone 356. Accordingly, the swap requests 406A and 406B are valid, and will be processed during the swap deny zone 358 of the present frame.

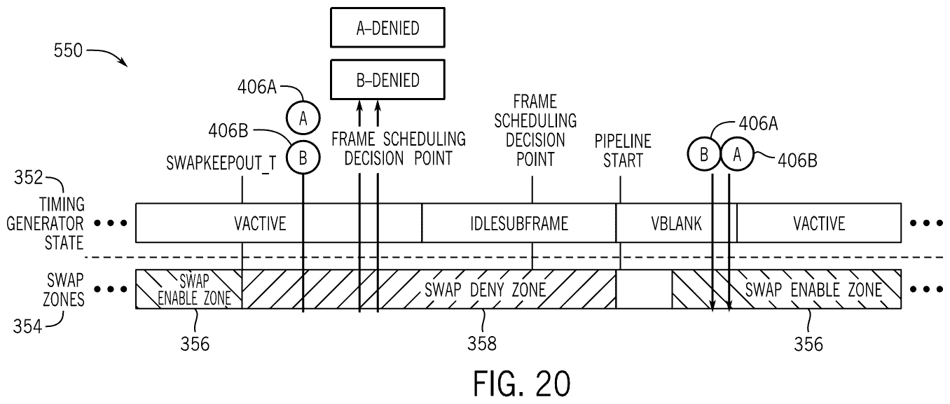

FIG. 20 is a timing diagram 550 illustrating a scenario wherein a swap request is denied in the dual-pipeline architecture 220 as discussed with respect to FIG. 13, according to embodiments of the present disclosure. From the timing diagram 550, it may be seen that the swap requests 406A and 406B are made simultaneously during the swap deny zone 358. Accordingly, the swap requests 406A and 406B are not valid, and the buffer swap will be processed during the subsequent frame of image data (e.g., the source buffer swap is not an immediate source buffer swap).

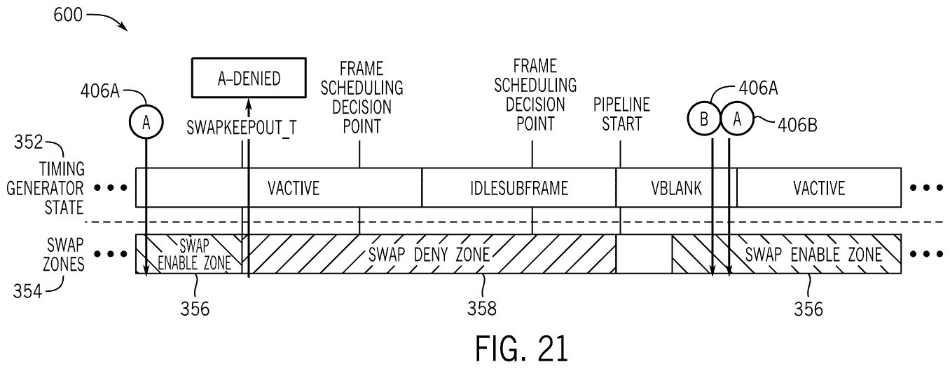

FIG. 21 is a timing diagram 600 illustrating another scenario wherein a swap request is denied in the dual-pipeline architecture 220 as discussed with respect to FIG. 13, according to embodiments of the present disclosure. From the timing diagram 600, it may be observed that the swap request 406A is made during the swap enable zone 356. However, the swap request 406A is unpaired with a corresponding swap request 406B for the display pipeline 200B. To ensure synchronization, a swap request 406 must be submitted for each corresponding display pipeline 200 in a display pipeline architecture. The image processing circuitry 28 will wait for all swap requests 406 until entry into the swap deny zone 358 (at which point it is too late to process a swap request). If all swap requests are not submitted before entry into the swap deny zone 358, all swap requests 406 will be determined invalid. Accordingly, the unpaired swap request 406A is not valid, and the buffer swap will be processed during the subsequent frame of image data (e.g., the source buffer swap is not an immediate source buffer swap).

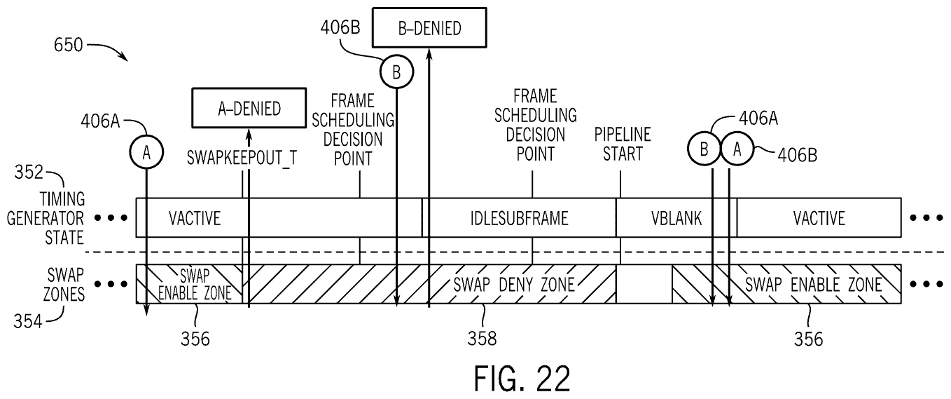

FIG. 22 is a timing diagram 650 illustrating another scenario wherein a swap request is denied in the dual-pipeline architecture 220 as discussed with respect to FIG. 13, according to embodiments of the present disclosure. From the timing diagram 650, it may be observed that the swap request 406A is made during the swap enable zone 356. However, the swap request 406A is unpaired with a corresponding swap request 406B for the display pipeline 200B, as the swap request 406B is not submitted until the swap deny zone 358. To ensure synchronization, a swap request 406 must be submitted for each corresponding display pipeline 200 in a display pipeline architecture during the swap enable zone 356 of a present frame. The image processing circuitry 28 will wait for all swap requests 406 until entry into the swap deny zone 358 (at which point it is too late to process a swap request). If all swap requests are not submitted before entry into the swap deny zone 358, all swap requests 406 will be determined invalid. While a subsequent request (e.g., the swap request 406B) may be submitted afterwards, it will also be denied as it occurs too late. Accordingly, the unpaired swap request 406A is not valid and the late swap request 406B is invalid, and the buffer swap will be processed during the subsequent frame of image data (e.g., the source buffer swap is not an immediate source buffer swap but is a delayed source buffer swap).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method, comprising:
determining a tear offset of a tear line to be displayed on an electronic display based on a set of buffering parameters;
determining a first location of the tear line on the electronic display based on the tear offset and a line of a destination buffer at which a request for a source buffer is approved; and
swapping from a first source buffer to a second source buffer at a second location determined based on the tear line.

2. The method of claim 1, wherein the set of buffering parameters comprises a buffering capacity available in a display pipeline, a number of lines available for buffering by image processing circuitry, a prefetch budget associated with the image processing circuitry, or any combination thereof.

3. The method of claim 2, wherein the tear offset is determined based on a summation of the buffering capacity available in the display pipeline, the number of lines available for buffering by the image processing circuitry, and the prefetch budget associated with the image processing circuitry.

4. The method of claim 2, wherein the image processing circuitry comprises a single-display-pipeline architecture.

5. The method of claim 2, wherein the image processing circuitry comprises a multi-display-pipeline architecture.

6. The method of claim 1, wherein swapping from the first source buffer to the second source buffer is configured to enable most recent image data rendered from a graphics processing unit (GPU) to be displayed on the electronic display.

7. The method of claim 1, comprising:
determining a request for a second source buffer swap from the first source buffer to the second source buffer;
determining whether a configuration change is present in a frame in which the second source buffer swap is requested; and
based on the configuration change being present, blocking the request for the second source buffer swap.

8. The method of claim 7, wherein the configuration change comprises image scaling, source format changes, ambient condition changes, or any combination thereof.

9. An electronic device, comprising:
a graphics processing unit (GPU);
a first source buffer configured to receive first image data from the GPU;
a second source buffer configured to receive second image data from the GPU; and
processing circuitry coupled to the first source buffer, the second source buffer, and the GPU, and configured to:
receive a request to swap from the first source buffer to the second source buffer; and
approve the request based on a timing of the request and determining that no other image data configuration change is present, wherein approving the request causes the processing circuitry to swap from the first source buffer to the second source buffer during display of the first image data.

10. The electronic device of claim 9, wherein the second image data is more recent than the first image data.

11. The electronic device of claim 9, wherein swapping from the first source buffer to the second source buffer comprises feeding the second image data to a destination buffer at a buffer address line corresponding to a tear line.

12. The electronic device of claim 11, wherein the tear line is determined based on a tear offset and a line of the destination buffer at which the request was approved.

13. The electronic device of claim 12, wherein the tear offset is based on a display pipeline buffer capacity, a number of lines buffered by the processing circuitry, a prefetch budget associated with the processing circuitry, or any combination thereof.

14. The electronic device of claim 13, wherein the display pipeline buffer capacity comprises a maximum display pipeline buffer capacity, and the prefetch budget associated with the processing circuitry comprises a maximum prefetch budget associated with the processing circuitry.

15. The electronic device of claim 14, wherein determining the maximum prefetch budget causes the processing circuitry to reduce an amount of data prefetched from the first source buffer.

16. The electronic device of claim 9, wherein the image data configuration change comprises image scaling, source format changes, ambient condition changes, or any combination thereof.

17. The electronic device of claim 9, wherein the processing circuitry is configured to approve the request based on the request being received during a present frame of image data prior to an idle subframe of the present frame of image data.

18. A tangible, non-transitory, computer-readable medium, comprising computer-readable instructions that, when executed, cause one or more processors to:
receive a first source buffer swap request associated with a first display pipeline;
receive a second source buffer swap request associated with a second display pipeline;
determine a first timing of the first source buffer swap request and a second timing of the second source buffer swap request; and
based on determining that the first source buffer swap request and the second source buffer swap request are synchronized, approve the first source buffer swap request and the second source buffer swap request.

19. The tangible, non-transitory, computer-readable medium of claim 18, wherein determining that the first source buffer swap request and the second source buffer swap request are synchronized comprises determining that the first source buffer swap request and the second source buffer swap request occur during a present frame of image data prior to an idle subframe of the present frame of image data.

20. The tangible, non-transitory, computer-readable medium of claim 18, wherein the instructions, when executed, cause the one or more processors to:
receive a third source buffer swap request associated with the first display pipeline;
receive a fourth source buffer swap request associated with the second display pipeline;
determine a third timing of the third source buffer swap request and a fourth timing of the fourth source buffer swap request; and
based on determining that the third source buffer swap request and the fourth source buffer swap request are not synchronized, cause the third source buffer swap request and the fourth source buffer swap request to be approved on a subsequent frame of image data.
